(19) United States
(12) Patent Application Publication
(10) Pub. No.: US 2018/0094856 A1
(43) Pub. Date: Apr. 5, 2018

(54) DEVICE FOR HEAT TREATMENT

(71) Applicant: Heraeus Noblelight GmbH, Hanau (DE)

(72) Inventors: Michael TITTMANN, Hanau (DE); Jürgen WEBER, Kleinostheim (DE)

(21) Appl. No.: 15/562,469

(22) PCT Filed: Mar. 8, 2016
(86) PCT No.: PCT/EP2016/054848

§ 371 Date: Sep. 28, 2017

(30) Foreign Application Priority Data
Mar. 31, 2015 (DE) 10 2015 104 932.5

(51) Int. Cl. F27B 9/06; F27B 9/24; C03B 29/08; C03B 35/18; F27D 3/06

(52) U.S. Cl. CPC F27B 9/063; F27B 9/243; F27D 3/06; C03B 35/181; C03B 35/185; C03B 29/08

(57) ABSTRACT

A device for heat treatment is provided. The device includes at least one processing chamber arranged in an elongated housing having a heating device and having a transport system for continuous transport of material to be treated through the processing chamber. The transport system has two parallel endless conveyor belts spaced from each other and a plurality of cylinders made of quartz glass that bridge the distance between the conveyor belts. The cylinders are supported on these belts and the material to be treated is supported on the cylinders for the heat treatment. The cylinders are designed as twin tubes, formed by two tubular compartments separated from each other by an intermediate partition. Each tubular compartment has a longitudinal axis and is connected rotation-free at its end with the conveyor belts.

### CROSS-REFERENCE TO RELATED APPLICATIONS

This application is a Section 371 of International Application No. PCT/EP2016/054848, filed Mar. 8, 2016, which was published in the German language on Oct. 6, 2016, under International Publication No. WO 2016/155987 A1 and the disclosure of which is incorporated herein by reference.

### BACKGROUND OF THE INVENTION

An embodiment of the invention relates to a device for heat treatment. The device comprises at least one processing chamber having a heating device and arranged in an elongated housing and having a transport system for the continuous transport of material to be treated through the processing chamber. The transport system has two parallel endless conveyor belts spaced from each other, and has a plurality of cylinders made of quartz glass that bridge the distance between the conveyor belts and which are supported on these belts, and on which the material to be treated is supported for the heat treatment.

Devices in this sense are suitable, in particular, for heating material to be treated at temperatures greater than 600° C.

In industrial electric heating furnaces, which are used to heat a material to be treated at temperatures greater than 600° C., infrared emitters that emit medium-wave and/or long-wave infrared radiation are usually used as heating elements. The infrared emitters are arranged multiple times within the processing chamber and generate a homogeneous thermal profile.

For special requirements, for example, for processes having high purity requirements, furnace linings made of quartz glass are used, wherein the infrared emitters which are equipped in this case with envelope tubes made of quartz glass, form at least a part of the lining of the processing chamber. A processing chamber constructed in this way for heat treatment is known, for example, from DE 10 2012 003 030 A1. For a continuous transport of material to be treated through the processing chamber, however, this must be controlled manually.

From U.S. Pat. No. 4,133,667 a continuous furnace for the heat treatment of glass panels is known. In a processing chamber of the continuous furnace, there are infrared emitters as heating elements above and below the glass panels to be treated. In another processing chamber, air is blown onto the glass panels from above and from below for the purpose of cooling. The transport system of this continuous furnace comprises a roller conveyor having cylindrical rollers made of quartz glass arranged transverse to the conveying direction, on which the glass panels are transported through the furnace. Details on the construction of the rollers come from U.S. Pat. No. 3,994,711. According to this reference, the rollers having a circular construction in radial cross section are supported at their ends on two metallic conveyor belts, wherein the rollers are made to turn by friction with the conveyor belts. In the section that contacts the conveyor belts, the ends of the rollers have a reduced diameter relative to the nominal diameter in the area of the carrying function of the rollers. The transport system is designed so that the rollers transport the material to be treated lying on them through the furnace by the rotating motion, wherein the rollers themselves move only slightly in the transport direction and remain on the upper plane of the conveyor belt, and thus are not in the closed circulation on the conveyor belt.

This arrangement results in the problem that, for very small differences in the speed of the conveyor belts, the rollers do not all have exactly the same rotating speed, which leads to different wearing of the rollers and which can be disruptive overall to the transport. In addition, the individual cylindrical rollers must be produced with very low production tolerances with respect to the diameter, which is associated with correspondingly high production costs. Moreover, depending on the material that lies on such a roller conveyor as the material to be treated, damage due to friction with the rotating rollers is not to be ruled out. There is also the risk of particle introduction into the material to be treated and into the processing chamber due to the friction of the roller on the metallic conveyor belt. It is also disadvantageous that the material to be treated is exposed to vibrations through the moving rollers, which could interfere with the process flow.

From JP 4715019 B2, a transport system having quartz glass rollers for a continuous furnace is known for the heat treatment of thin glass panels (displays). The quartz glass rollers are supported on a revolving conveyor belt and made to roll individually synchronized by a drive. The drive technology is complicated and susceptible to interference. There is also the risk here of vibrations and damage to the material to be treated by the friction with the rotating rollers.

### BRIEF SUMMARY OF THE INVENTION

An embodiment of the invention is based on an objective of providing a device for heat treatment having a transport system for the continuous transport of material to be treated through a processing chamber. By such a device, the disadvantages of the prior art are avoided, a reliable operation with material of variable geometric shape to be treated, optionally even with high intrinsic weight, is enabled; and the device is distinguished by a long service life.

### BRIEF DESCRIPTION OF THE SEVERAL VIEWS OF THE DRAWINGS

The foregoing summary, as well as the following detailed description of the invention, will be better understood when read in conjunction with the appended drawings. For the purpose of illustrating the invention, there are shown in the drawings embodiments which are presently preferred. It should be understood, however, that the invention is not limited to the precise arrangements and instrumentalities shown.

In the drawings:

FIG. 1 shows a longitudinal section of the device for heat treatment, according to an embodiment of the invention;

FIG. 2 shows a cross-section of the device for heat treatment in the area of the processing chamber, according to an embodiment of the invention;

FIG. 3a shows a detailed view of the mounting of the twin tubes with clamping springs, according to an embodiment of the invention; and

FIG. 3b shows a detailed view of the cross-sectional geometry of a twin tube, according to an embodiment of the invention.

### DETAILED DESCRIPTION OF THE INVENTION

Starting from a device for heat treatment having the features specified above, embodiments of the present invention comprises cylinders are constructed as twin tubes, formed by two tubular compartments separated from each other by an intermediate partition, and each having a longitudinal axis and being connected at their ends rotation-free with the conveyor belts.

In comparison with known devices of a continuous furnace having a transport system, which has quartz glass support elements made of round tubes or rods, an embodiment according to the invention is distinguished by significantly improved quartz glass support elements, namely such that twin tubes are used as the support elements, which are connected at their ends rotation-free with the conveyor belts. Twin tubes have a double tube geometry, which are formed by two parallel tubular compartments that are separated by an intermediate partition. The compartments each have a longitudinal axis. The radial cross-section of the twin tubes perpendicular to the parallel longitudinal axes of the compartments has a shape similar to a figure eight. The outer dimension of the two compartments is specified as the width of a twin tube, when in radial cross-section the two longitudinal axes lie in a horizontal plane, thus having the shape of a lying figure eight.

The twin tubes made of quartz glass have, depending on the material, a high fracture strength that is significantly increased by the special geometry as a twin tube. In comparison to round tubes made of quartz glass having comparable wall thicknesses and outer diameters, it is possible to significantly increase the load carrying capacity per surface unit by using twin tubes. In this way, material to be treated having high intrinsic weight can be securely guided through the processing chamber on the transport system having twin tubes, and can at the same time withstand high temperatures.

Due to the rotation-free support of the twin tubes on the two conveyor belts, vibrations are minimized. In addition, particle formation is suppressed, because unlike in the prior art, non-moving rollers are used. The device according to the invention therefore has an especially long service life.

In one preferred embodiment of the device according to the invention, the twin tubes are mounted on the conveyor belts, such that the longitudinal axes of the compartments lie in a common horizontal plane. In this way, the material to be treated lies on the relatively wide surface of the twin tube. Even for a small-part material to be treated, this arrangement of the twin tubes is advantageous, especially if the twin tubes are mounted on the conveyor belts at a small distance from each other.

This arrangement of the twin tubes having their wide surface as the support surface, however, is also well suited for material having elongated geometry to be treated, because in this case, the distance between the twin tubes can be kept large and for an arrangement of the heating device in the processing chamber, even underneath the transport system, the heat can act directly on the large surfaces of the material to be treated.

An alternative embodiment for the arrangement of the twin tubes comprises having the twin tubes mounted on the conveyor belts, such that the longitudinal axes lie in a common vertical plane. The contact surface between the material to be treated and the twin tube is minimized in this arrangement, which is advantageous for an especially sensitive surface of the material to be treated. In addition, the height at which the material to be treated passes through the processing chamber is somewhat increased by this installation arrangement of the twin tubes, without requiring the entire transport system to be lifted.

Advantageously, the twin tubes are held in clamping springs, which are each connected to a conveyor belt. Clamping springs represent a secure and simple fastening solution for the twin tubes. For the connection to the conveyor belts or to a transport chain, angle elements can also be used. Instead of clamping springs, retaining springs can also be used as fasteners for the twin tubes.

In order to subject treatment material having an especially high intrinsic weight to a heat treatment in the device according to an embodiment of the invention, the twin tubes have an average wall thickness in a range of 1.5 mm to 2.5 mm and a high load carrying capability per surface unit.

According to how the maximum temperature of the continuous furnace is set, up to 90% of the length of the twin tubes can be used for supporting the material to be treated. Here it is decisive that only a small section of length of the twin tubes is needed for the rotation-free mounting on the conveyor belts, but it must lie at an appropriate distance from the processing chamber in the cold area of the housing. The passage width of the transport system or the usable length of the twin tubes can be optimized, so that the device is suitable for operating at a high throughput by parallel placement of material to be treated on a large passage width.

It has proven effective if the twin tubes have at least partially a coating made of opaque, highly reflective quartz glass. Such a coating reflects the infrared radiation of the heating device, and thus contributes to the efficiency of the heat treatment. The coating also prevents slippage of the material to be treated by the roughness of the coating in comparison to the extremely smooth surface of an uncoated twin tube.

With respect to the processing chamber, it has proven effective if the processing chamber comprises a lining made of infrared radiant heaters having envelope tubes constructed as twin tubes made of quartz glass, which have a side facing the processing chamber and a side facing away from the processing chamber, and which are connected to each other by a connecting material containing SiO₂.

The connecting material containing SiO₂ is used simultaneously as a reflector and as a connector, and is deposited either on the side of the infrared radiant heater facing the processing chamber or on the side facing away from the processing chamber.

Twin tubes can be manufactured economically. They have two hollow spaces in the form of compartments that contribute to an insulation of the lining of the processing chamber. In accordance with an embodiment of the invention, by connecting the twin tubes with a connecting material containing SiO₂, a lining of the processing chamber is created that consists essentially of quartz glass. Such a lining has a high temperature resistance. It enables high operating temperatures up to 1000° C.

The connecting material containing SiO₂ has a high temperature stability and thermal shock resistance. Where the connecting material containing SiO₂ is deposited on the side of the radial heater facing the processing chamber, an energy-efficient heat treatment of the material to be treated is made possible. Here, both the loss of energy is minimized and also the introduction of energy into the lining of the processing chamber is prevented, so that the energy introduced into the processing chamber by the heating device is available to an increased degree for the heat treatment of the material to be treated.

In one alternative embodiment, the connecting material containing SiO₂ is deposited on the side of the infrared radiant heater facing away from the processing chamber.

A connecting material containing SiO₂ deposited on the side facing away from the processing chamber also leads to reduced energy loss. Where the coating is deposited on the side of the infrared radiant heater facing away from the processing chamber, it acts as a reflective layer for the emitter itself. In this way, it is exposed to lower temperature fluctuations. In comparison to a coating that is deposited on the side facing the processing chamber, such a coating has a longer service life.

Devices for heat treatment having the previously mentioned features are used, for example, for the production of glass components having a gold layer, especially a gold reflector layer. Glass components of this type are, for example, infrared radiant heaters having a gold reflector layer. A plurality of such infrared radiant heaters can pass simultaneously through the device, whereby a contamination-free transport is ensured. The burning-in of gold decorative materials can also be performed using the device according to the invention with a high throughput and without the risk of introducing foreign metallic particles from the transport system.

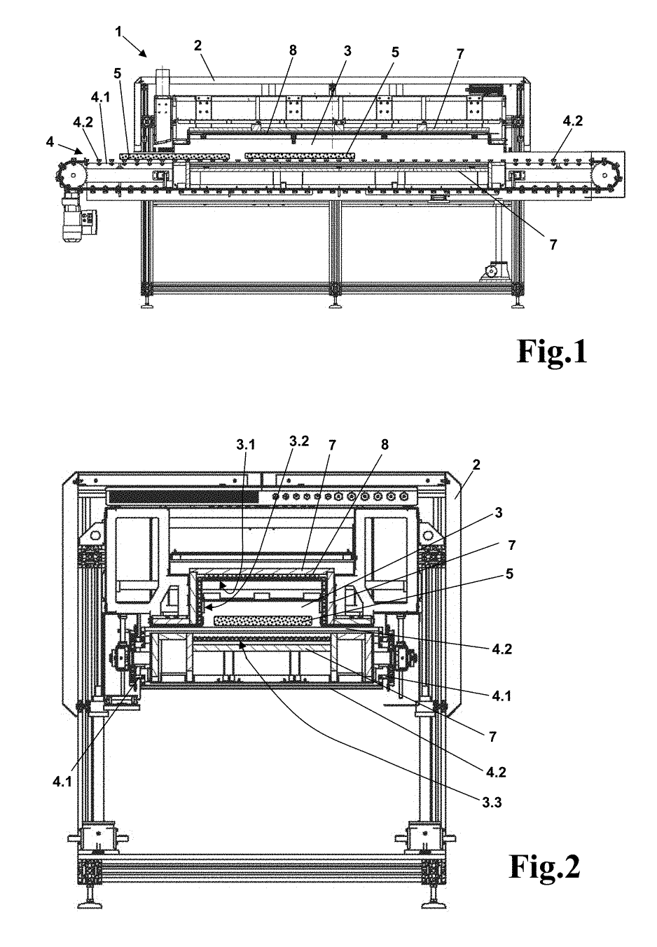

FIG. 1 shows a longitudinal section of a continuous furnace in the sense of the device for heat treatment, according to an embodiment of the invention, which is designated overall by the reference numeral 1. The device 1 comprises a furnace housing 2 in which is located a processing chamber 3 (shown in more detail in FIG. 2) for heat treatment, and a transport system 4 for the continuous transport through the processing chamber 3 of material 5 to be treated. The transport system 4 (only partially visible in FIG. 1 due to the longitudinal section illustration) comprises two parallel, endless conveyor belts 4.1 spaced from each other and having carrier elements that bridge the distance between the conveyor belts and are held rotation-free on these belts in the form of transparent twin tubes 4.2 made of quartz glass, on which the material 5 to be treated can be supported for heat treatment.

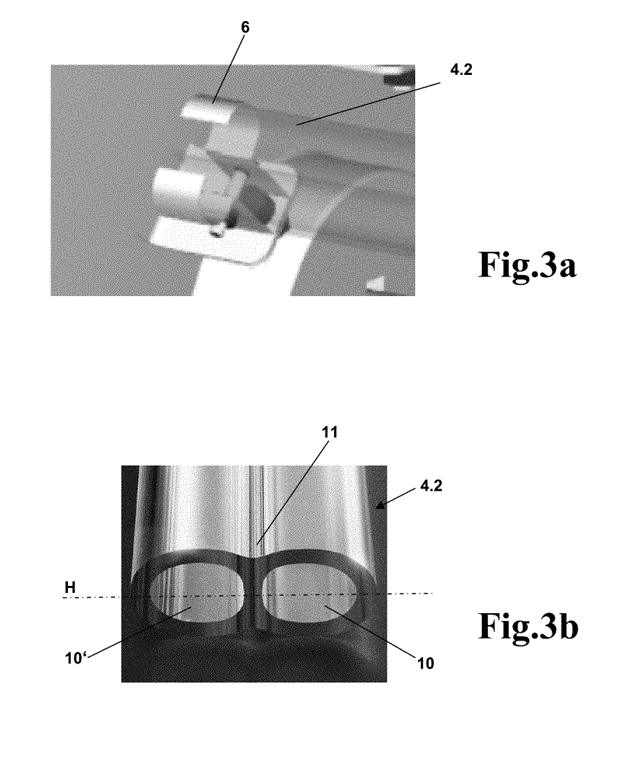

A detailed view of the rotation-free mounting of the twin tubes 4.2 is shown in FIG. 3a. A clamping spring 6 encloses the end of a twin tube 4.2 and fixes it in a rotation-free position on one of the conveyor belts (not shown here). The clamping spring 6 is connected to angles that are, in turn, mounted on one of the conveyor belts 4.1.

FIG. 3b shows a detailed view of the cross-sectional geometry of a twin tube 4.2. Twin tubes have a double tube geometry formed by two parallel tubular compartments 10, 10′, which are separated by an intermediate partition 11. The radial cross-section has a shape similar to a figure eight. As the width of a twin tube, the outer dimension of the two compartments 10, 10′ is indicated when, in radial cross-section, the two longitudinal axes are in a horizontal plane H, thus having the shape of a lying figure eight, as shown in FIG. 3b.

The individual twin tubes 4.2 have dimensions of 1000 mm×34 mm×14 mm with respect to length×width×height (L×W×H). The wall thickness is approximately 2 mm. The spacing of the twin tubes 4.2 from each other varies according to the weight and geometry of the material 5 to be treated. For the use of the device 1, according to an embodiment of the invention, for burning in a gold layer on quartz glass tubes for manufacturing lamps, a distance of 150 mm is typically set between the twin carrier tubes. The twin tubes 4.2 used are suitable for supporting material 5 to be treated having a high intrinsic weight, and also to securely and reliably transport the material through the continuous furnace even under the effects of very high heating. The two conveyor belts 4.1 run outside of the heated area and still must be cooled with an airflow. The housing has a cutout that defines the passage height and passage width for the material 5 to be treated.

In FIG. 2, a cross-sectional view of the device 1 according to an embodiment the invention is shown, with a view into the processing chamber 3. The processing chamber 3 is surrounded by one layer of thermal insulation 7 in the ceiling, sides, and floor areas. The insulation 7 is made of a fire-resistant high-temperature mat based on aluminum oxide and silicon oxide, and has a thickness of 25 mm. Inside of the thermal insulation 7, the processing chamber 3 is provided with a lining made by heating elements in the form of infrared radiant heaters 8. The processing chamber 3 has a length of 2000 mm, a width of 420 mm, and a height (calculated from the plane of the twin tubes 4.2 of the transport system) of 145 mm. The radiant heaters 8 have envelope tubes made of quartz glass formed as twin tubes, which have a side facing the processing chamber 3 and a side facing away from the processing chamber 3, and which are connected to each other by a connecting material containing SiO₂. The radiant heaters have, on their side facing away from the processing chamber, an opaque, highly reflective coating made of quartz glass, which comprises the same connecting material containing SiO₂ and also connects the radiant heaters 8 to each other. The coating comprises a very large number of small quartz beads having a diameter of approximately 10 nanometers up to 50 micrometers. The solid, sintered, and suitably porous SiO₂ material, whose pores are filled with air, has an enormous surface area due to the tiny structures, in particular, approximately 5 m² per gram of material. This large surface area promotes the quick indirect heating of the air in the pores via the direct heating of the quartz glass by infrared radiation.

Radiant heaters 8 coated in this way, and optionally also connected to each other, are located on the ceiling 3.1 of the processing chamber 3. In each of the twin tubes of the heating device, a heating wire (filament) is inserted. The ends of the twin tubes are sealed with a ceramic base. The electrical power of the filaments is designed so that surface power of 100 kW/m² is produced for the radiant heaters 8 on the ceiling 3.1.

The radiant heaters 8 are each arranged one next to the other and alternate with twin tubes without a heating filament with the side facing the processing chamber 3 or the side facing away from this processing chamber. The twin tubes without a heating filament also have the reflective layer made of quartz glass, but here on their side facing the processing chamber. In this way, a radiant heater 8 lies opposite a twin tube without a heating filament, which reflects the infrared radiation emitted by the radiant heater 8 due to the reflective layer on the side facing the processing chamber 3. This arrangement produces an optimal, homogeneous heating profile in the processing chamber.

In principle, radiant heaters can also be provided on the side walls 3.2 and on the floor 3.3 in the manner as they are provided on the ceiling. In the processing chamber 3 shown here, the radiant heaters 8 on the ceiling 3.1 are sufficient, so that twin tubes without heating filaments are arranged on the side walls 3.2 and on the floor 3.3 of the processing chamber 3, underneath the support elements of the transport system 4. These twin tubes are provided with a reflective layer made of quartz glass on their side facing the processing chamber 3, and thus reflect the infrared radiation emitted by the radiant heaters 8 and reflected from the material 5 to be treated and/or from the twin carrier tubes 4.2 of the transport system 4. This arrangement contributes to an optimization of the homogeneous heating profile in the processing chamber.

The device 1 according to an embodiment of the invention is operated as a continuous furnace (electrical continuous power 20 kW) and used for a continuous sintering process. For this purpose, components coated on the top side with gold, for example quartz tubes having the dimensions L×W×H=1000×34×14 mm, for burning in the coating are placed on the twin tubes 4.2 of the transport systems 4 and are guided with the speed of 200 mm/min through the hot processing chamber 3. Ten tubes are placed next to each other, so that a throughput of approximately 100 tubes per hour is realized. The device 1 has a passage height of 100 mm and a passage width of 420 mm.

After passing through the device 1, the coating has a visually homogeneous surface having very good surface adhesion on the tubes. The adhesion of the gold on the surface is determined by the adhesive tape tear-off test. This test includes applying a commercially available adhesive tape, for example a Scotch tape made by 3M, on the gold-plated surface and pulling it off again with a jerking motion. If the adhesive power of the gold is not sufficient, metallic residue remains on the adhesive surface of the tape. The metallic, coated surface exhibits absolutely no negative effects due to particles or foreign materials, because with the device 1, according to embodiments of the invention, no moving support elements are used, which could release particles due to friction on the material 5 to be treated or on other surfaces. Moreover, the processing chamber 3 essentially has surfaces made of quartz glass, so that processing can also be performed without contamination and without generating particles in this area.

Where the same reference symbols are used in FIGS. 1 to 3, these designate structurally identical or equivalent components and parts, as explained in more detail with reference to the description for FIG. 1.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

1-11. (canceled)

12. Heat treatment device comprising:
at least one processing chamber (3) arranged in an elongated housing (2) having a heating device and having a transport system (4) for continuous transport through the processing chamber (3) of a material (5) to be treated,
wherein the transport system (4) has two parallel endless conveyor belts (4.1) spaced from each other and a plurality of cylinders made of quartz glass that bridge the distance between the conveyor belts and are supported on these belts and on which the material (5) to be treated is supported for the heat treatment, and
wherein the cylinders are designed as twin tubes (4.2) formed from two tubular compartments (10; 10′) separated from each other by an intermediate partition (11), each tubular compartment having a longitudinal axis and being connected rotation-free at its end with a respective conveyor belt (4.1).

13. Heat treatment device according to claim 12, wherein the twin tubes (4.2) are mounted on the conveyor belts (4.1) such that the longitudinal axes lie in a common horizontal plane (H).

14. Heat treatment device according to claim 12, wherein the twin tubes (4.2) are mounted on the conveyor belts (4.1) such that the longitudinal axes lie in a common vertical plane.

15. Heat treatment device according to claim 12, wherein the twin tubes (4.2) are held in clamping springs (6), which are each connected to a conveyor belt (4.1).

16. Heat treatment device according to claim 12, wherein the twin tubes (4.2) have at least partially a coating made of opaque, highly reflective quartz glass.

17. Heat treatment device according to claim 12, wherein the processing chamber (3) comprises a lining made of infrared radiant heaters (8) having envelope tubes made of quartz glass and constructed as twin tubes, which have a side facing the processing chamber and a side facing away from the processing chamber, and which are connected to each other by a connecting material containing SiO₂.

18. Heat treatment device according to claim 17, wherein the connecting material containing SiO₂ is simultaneously used as a reflector and as a fastener.

19. Heat treatment device according to claim 17, wherein the connecting material containing SiO₂ is deposited on the side of the infrared radiant heater (8) facing the processing chamber (3).

20. Heat treatment device according to claim 17, wherein the connecting material containing SiO₂ is deposited on the side of the infrared radiant heater (8) facing away from the processing chamber (3).

21. Heat treatment device according to claim 17, wherein the infrared radiant heaters (8) have heating filaments that produce a total surface output power of the heating device in a range of 80 kW/m² to 120 kW/m².

22. Use of the heat treatment device according to claim 12 for producing glass components having a gold layer, in particular a gold reflector layer.
